(19) United States
(12) Patent Application Publication
(10) Pub. No.: US 2025/0190035 A1
(43) Pub. Date: Jun. 12, 2025

(54) OPTIMIZATION APPARATUS, OPTIMIZATION METHOD, AND STORAGE MEDIUM

(71) Applicant: NEC Corporation, Minato-ku, Tokyo (JP)

(72) Inventor: Tatsuya MORI, Tokyo (JP)

(73) Assignee: NEC Corporation, Minato-ku, Tokyo (JP)

(21) Appl. No.: 18/846,361

(22) PCT Filed: Jun. 3, 2022
(86) PCT No.: PCT/JP2022/022680

§ 371 Date: Sep. 12, 2024

(51) Int. Cl. G06F 1/20

(52) U.S. Cl. CPC G06F 1/206

(57) ABSTRACT

In order to attain the object of adjusting an inverse temperature used in a nonlinear optimization problem to a more suitable value, an optimization apparatus (100) includes: an optimal variable candidate generation section (101) that generates a plurality of optimal variable candidates, based on a belief distribution; an objective function evaluation section (102) that evaluates an objective function for each of the plurality of optimal variable candidates; an inverse temperature optimization section (103) that calculates, by using an optimization technique, an inverse temperature such that a target effective sample size which has been inputted and an effective sample size of a weight for the objective function are substantially equal to each other; a weight evaluation section (104) that calculates the weight for the objective function, based on the inverse temperature; and a belief distribution updating section (105) that updates the belief distribution, based on the weight, the belief distribution, and each of the optimal variable candidates.

### TECHNICAL FIELD

The present invention relates to a technique for solving nonlinear optimization problems.

### BACKGROUND ART

In nonlinear optimization problems, techniques for approximately calculating optimal variables without using gradient values of objective functions are known. For example, Non-Patent Literatures 1 and 2 disclose information theoretic model predictive control (ITMPC) as an example of such a technique. ITMPC involves (i) determining weights for Bayesian updating by referring to the objective function value and the inverse temperature for each of a plurality of optimal variable candidates generated on the basis of a belief distribution and (ii) updating the belief distribution by referring to the plurality of optimal variable candidates and the respective weights thereof. In addition, ITMPC outputs an approximate solution by referring to the updated belief distribution through repeating the processes of (i) and (ii).

### CITATION LIST

### Non-Patent Literature

### Non-Patent Literature 1

Grady Williams, et al., “Information Theoretic MPC for Model-Based Reinforcement Learning”, ICRA2017

### Non-Patent Literature 2

Grady Williams, et al., “Information Theoretic Model Predictive Control: Theory and Applications to Autonomous Driving”, IEEE Transactions on Robotics (Volume: 34, Issue: 6, December 2018)

### SUMMARY OF INVENTION

### Technical Problem

An inverse temperature is a parameter for determining the efficiency and accuracy of an optimization system. In

Bayesian updating, a suitable value of the inverse temperature can vary depending on the situation at the time, such as the results of generating optimal variable candidates, the content of objective functions, or the shape of a belief distribution. If the inverse temperature is not suitable, the effective sample size may become unsuitable and therefore leads to problems in Bayesian updating. The techniques disclosed in Non-Patent Literatures 1 and 2 have the problem that it is difficult to adjust the inverse temperature because it is not possible to know up to the suitable value for the inverse temperature.

An example aspect of the present invention has been made in view of the above problem, and an example object thereof is to provide a technique for adjusting an inverse temperature used in nonlinear optimization problems to a more suitable value.

### Solution to Problem

An optimization apparatus in accordance with an example aspect of the present invention includes: an optimal variable candidate generation means for generating a plurality of optimal variable candidates, based on a belief distribution; an objective function evaluation means for evaluating an objective function for each of the plurality of optimal variable candidates; an inverse temperature optimization means for calculating, by using an optimization technique, an inverse temperature such that a target effective sample size which has been inputted and an effective sample size of a weight for the objective function are substantially equal to each other; a weight evaluation means for calculating the weight for the objective function, based on the inverse temperature; and a belief distribution updating means for updating the belief distribution, based on the weight, the belief distribution, and each of the optimal variable candidates.

An optimization method in accordance with an example aspect of the present invention includes: generating a plurality of optimal variable candidates, based on a belief distribution; evaluating an objective function for each of the plurality of optimal variable candidates; calculating, by using an optimization technique, an inverse temperature such that a target effective sample size which has been inputted and an effective sample size of a weight for the objective function are substantially equal to each other; calculating the weight for the objective function, based on the inverse temperature; and updating the belief distribution, based on the weight, the belief distribution, and each of the optimal variable candidates.

A program in accordance with an example aspect of the present invention causes a computer to function as an optimization apparatus, the program causing the computer to function as: an optimal variable candidate generation means for generating a plurality of optimal variable candidates, based on a belief distribution; an objective function evaluation means for evaluating an objective function for each of the plurality of optimal variable candidates; an inverse temperature optimization means for calculating, by using an optimization technique, an inverse temperature such that a target effective sample size which has been inputted and an effective sample size of a weight for the objective function are substantially equal to each other; a weight evaluation means for calculating the weight for the objective function, based on the inverse temperature; and a belief distribution updating means for updating the belief distribution, based on the weight, the belief distribution, and each of the optimal variable candidates.

### Advantageous Effects of Invention

An example aspect of the present invention makes it possible to adjust an inverse temperature used in nonlinear optimization problems to a more suitable value.

### BRIEF DESCRIPTION OF DRAWINGS

FIG. 1 is a block diagram illustrating a configuration of an optimization apparatus in accordance with a first example embodiment of the present invention.

FIG. 2 is a flowchart illustrating a flow of an optimization method in accordance with the first example embodiment of the present invention.

FIG. 3 is a block diagram illustrating a configuration of an optimization system in accordance with a second example embodiment of the present invention.

FIG. 4 is a flowchart illustrating a flow of an optimization method in accordance with the second example embodiment of the present invention.

FIG. 5 is a block diagram illustrating a configuration of an optimization system in accordance with a third example embodiment of the present invention.

FIG. 6 is a flowchart illustrating a flow of an optimization method in accordance with the third example embodiment of the present invention.

FIG. 7 is a block diagram illustrating a configuration of an optimization system in an application example of the present invention.

FIG. 8 is a diagram schematically illustrating an example of a movable range of a control lever in the application example of the present invention.

FIG. 9 is a flowchart illustrating a flow of an optimization method in the application example of the present invention.

FIG. 10 is a diagram schematically for discussing a reference trajectory in the application example of the present invention.

FIG. 11 is a set of graphs for comparing a related technique and the application example of the present invention.

FIG. 12 is a set of other graphs for comparing the related technique and the application example of the present invention.

FIG. 13 is a table for comparing the related technique and the application example of the present invention.

FIG. 14 is another table for comparing the related technique and the application example of the present invention.

FIG. 15 is a block diagram illustrating a configuration of an optimization system according to the related technique.

FIG. 16 is a flowchart illustrating a flow of the process of the optimization system illustrated in FIG. 15.

FIG. 17 is a diagram illustrating an example of a hardware configuration of each apparatus in each example embodiment and application example.

### EXAMPLE EMBODIMENTS

### [Fundamental Findings of Present Invention]

The inventor of the present invention have found that, in Bayesian updating for solving nonlinear optimization problems, focusing on the correlation between an inverse temperature and an effective sample size allows obtaining a suitable value for the inverse temperature. The details of the findings will be discussed below.

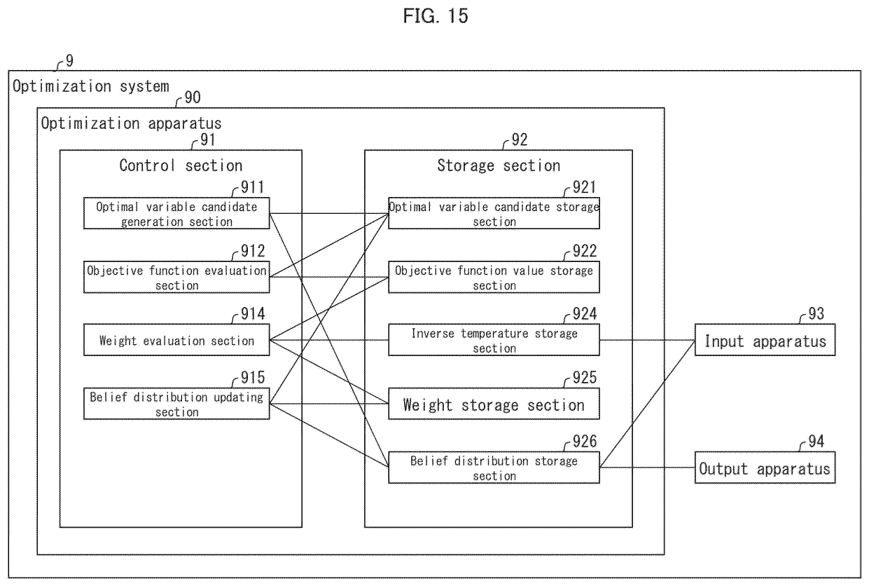

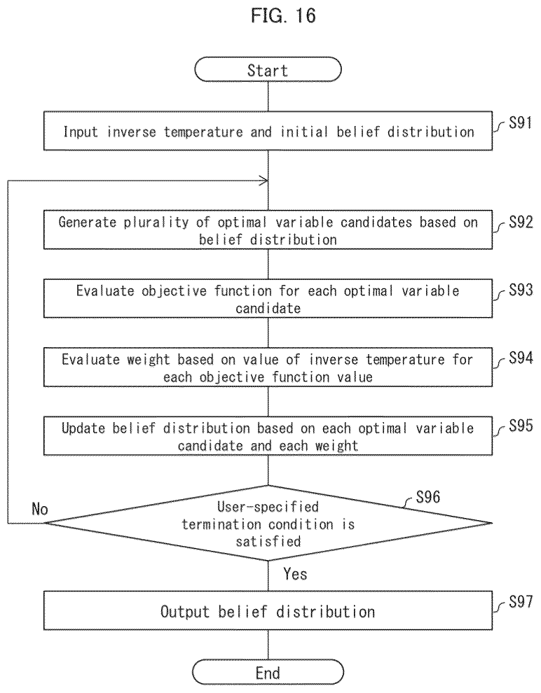

First, ITMPC, which is a related technique disclosed in Non-Patent Literatures 1 and 2, will be discussed with reference to FIGS. 15 and 16. FIG. 15 is a block diagram illustrating a configuration of an optimization system 9 that solves nonlinear optimization problems using ITMPC. FIG. 16 is a flowchart illustrating a flow of the process by the optimization system 9.

As illustrated in FIG. 15, the optimization system 9 includes an optimization apparatus 90, an input apparatus 93, and an output apparatus 94. The optimization apparatus 90 includes a control section 91 and a storage section 92. The control section 91 includes an optimal variable candidate generation section 911, an objective function evaluation section 912, a weight evaluation section 914, and a belief distribution updating section 915. The storage section 92 includes an optimal variable candidate storage section 921, an objective function value storage section 922, an inverse temperature storage section 924, a weight storage section 925, and a belief distribution storage section 926.

The optimization system 9 operates, for example, as illustrated in FIG. 16. In a step S91, the control section 91 obtains an inverse temperature inputted by a user via the input apparatus 93 and records the inverse temperature in the inverse temperature storage section 924. The control section 91 also obtains a belief distribution inputted by a user via the input apparatus 93 and records the belief distribution in the belief distribution storage section 926.

Next, the control section 91 repeatedly performs steps S92 through S96. In the step S92, the optimal variable candidate generation section 911 generates a plurality of optimal variable candidates on the basis of a belief distribution that is recorded in the belief distribution storage section 926, and records the optimal variable candidates in the optimal variable candidate storage section 921. In the first iteration of the repeated process, the belief distribution used for the generation is an input initial belief distribution which has been inputted in the step S91. In the second and subsequent iterations of the repeated process, the belief distribution used for the generation is the belief distribution which has been updated in the step S95 discussed later.

In the step S93, the objective function evaluation section 912 evaluates the objective function for each optimal variable candidate recorded in the optimal variable candidate storage section 921 and records each evaluated value in the objective function value storage section 922. Hereinafter, an evaluated value obtained by evaluating an objective function will also be referred to as “objective function value”. The objective function value may also be simply referred to as “objective function”.

In the step S94, the weight evaluation section 914 refers to each objective function value recorded in the objective function value storage section 922 and the inverse temperature recorded in the inverse temperature storage section 924, and then evaluates the weight for Bayesian updating, that is, a value obtained by dividing the likelihood by the marginal likelihood, for each optimal variable candidate. The weight evaluation section 914 then records the weight in the weight storage section 925.

In the step S95, the belief distribution updating section 915 refers to the each weight recorded in the weight storage section 925, each optimal variable candidate recorded in the optimal variable candidate storage section 921, and the belief distribution recorded in the belief distribution storage section 926, and then approximately calculates the posterior belief distribution as a new belief distribution. The belief distribution updating section 915 then records the new belief distribution in the belief distribution storage section 926.

In the step S96, the control section 91 determines whether or not a predetermined termination condition is satisfied. The predetermined termination condition may be specified by a user. If it is determined in the step 96 that the predetermined termination condition is satisfied (“Yes”), the control section 91 in the step S97 outputs, to the output apparatus 94, the belief distribution recorded in the belief distribution storage section 926. In addition, the control section 91 employs the optimal variable candidate which is the mode of the belief distribution, as the approximate solution to the target optimization problem, that is, the approximate optimal variable. The control section 91 then outputs the approximate solution.

If it is determined in the step S96 that the predetermined termination condition is not satisfied (“No”), the control section 91 refers to the belief distribution recorded in the belief distribution storage section 926 and repeats the process starting from the step S92.

It should be noted here that the likelihood function L in ITMPC is defined by the following formula (A1).

$$L ( v ) = exp ( - \frac{S ( v )}{λ} ) \qquad ( A 1 )$$

In the formula (A1), v is an optimal variable candidate, and S is an objective function. In addition, A is an inverse temperature and is a hyperparameter having a positive real value. It should be noted that although 1/A=B can be referred to as an inverse temperature, A is referred to as an inverse temperature in the present specification. The likelihood function L represents the probability that v is the optimal variable. As the objective function value becomes smaller than A, the probability exponentially approaches 1, whereas as the objective function value becomes larger than A, the probability exponentially approaches 0. That is, the inverse temperature λ can be interpreted as a type of threshold that determines whether or not the optimal variable candidate v is optimal.

The inverse temperature λ can also be interpreted as a hyperparameter that adjusts the amount of variation in the belief distribution for each Bayesian update. The formula (A1) suggests that the smaller the inverse temperature A, the greater the amount of variation and that the larger the A, the smaller the amount of variation. However, in practical applications, it is necessary to approximately calculate the posterior belief distribution, and the smaller the A, the worse the approximation accuracy. This leads to a lack of accuracy in the optimization method. Thus, the inverse temperature A is also a parameter that determines the efficiency and accuracy of the optimization system 9, and the adjustment of the inverse temperature λ is important for practical applications.

The problem with such ITMPC is that, despite the importance of adjusting the inverse temperature to obtain high-quality approximate optimal variables, the adjustment is difficult. This is because in Bayesian updating, the suitable value of the inverse temperature varies depending on the situation at the time, such as the results of generating optimal variable candidates, the content of the objective function, and shape of the belief distribution.

It should be noted here that if the inverse temperature is not suitable, the effective sample size in importance sampling is likely to become unsuitable. For example, if the inverse temperature λ is excessively small, there will be many samples for which the likelihood L(v) becomes zero. This results in a small effective sample size. Consequently, the error in Bayesian updating due to sample approximation becomes large. If, for example, the inverse temperature λ is excessively large, there will be many samples for which the likelihood L(v) becomes 1. This leads to no difference between samples, and therefore the Bayesian updating does not progress.

Hence, the inventor of the present invention have found that in order to accurately solve nonlinear optimization problems, it is only necessary to estimate an inverse temperature A such that the effective sample size reaches a target value and to use the estimated inverse temperature. Example embodiments of the present invention based on this finding will be discussed below.

### First Example Embodiment

The following description will discuss a first example embodiment of the present invention in detail with reference to the drawings. The present example embodiment is a basic form of example embodiments discussed later.

### <Configuration of Optimization Apparatus 100>

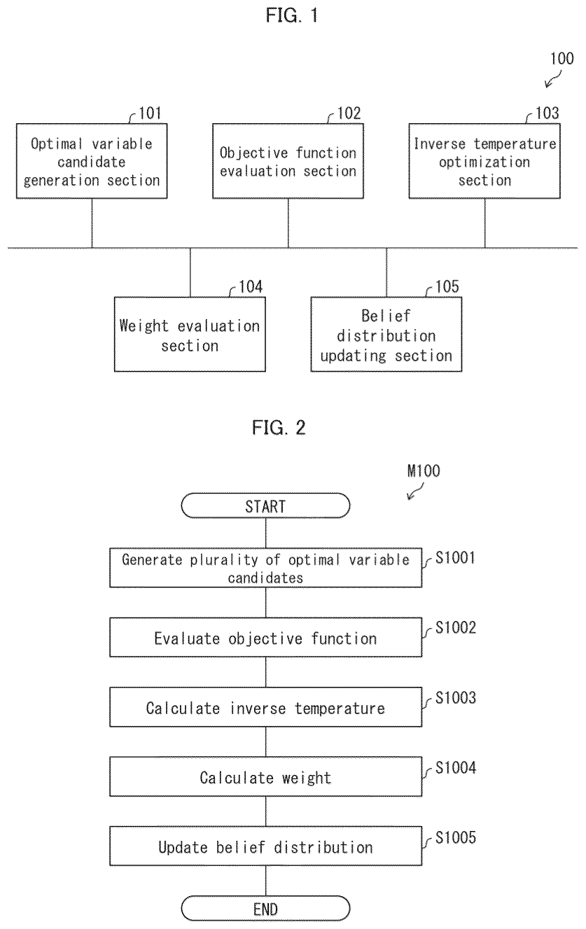

A configuration of an optimization apparatus 100 in accordance with the present example embodiment will be discussed with reference to FIG. 1. FIG. 1 is a block diagram illustrating the configuration of the optimization apparatus 100.

As illustrated in FIG. 1, an optimization apparatus 100 includes an optimal variable candidate generation section 101, an objective function evaluation section 102, an inverse temperature optimization section 103, a weight evaluation section 104, and a belief distribution updating section 105. Although the optimal variable candidate generation section 101 may achieve the optimal variable candidate generation means recited in the Claims, the present inventions is not limited to this configuration. Although the objective function evaluation section 102 may achieve the objective function evaluation means recited in the Claims, the present inventions is not limited to this configuration. Although the inverse temperature optimization section 103 may achieve the inverse temperature optimization means recited in the Claims, the present inventions is not limited to this configuration. Although the weight evaluation section 104 may achieve the weight evaluation means recited in the Claims, the present inventions is not limited to this configuration. Although the belief distribution updating section 105 may achieve the belief distribution updating means recited in the Claims, the present inventions is not limited to this configuration.

The optimal variable candidate generation section 101 generates a plurality of optimal variable candidates, based on a belief distribution. The objective function evaluation section 102 evaluates an objective function for each of the plurality of optimal variable candidates. The inverse temperature optimization section 103 calculates, by using an optimization technique, an inverse temperature such that a target effective sample size which has been inputted and an effective sample size of a weight for the objective function are substantially equal to each other. The weight evaluation section 104 calculates the weight for the objective function, based on the inverse temperature. The belief distribution updating section 105 updates the belief distribution, based on the weight, the belief distribution, and each of the optimal variable candidates.

### <Flow of Optimization Method M100>

The optimization apparatus 100, which is configured as discussed above, carries out an optimization method M100 in accordance with the present example embodiment. The flow of the optimization method M100 will be discussed with reference to FIG. 2. FIG. 2 is a flowchart illustrating the flow of the optimization method M100. As illustrated in FIG. 2, the optimization method M100 includes steps S1001 through S1005.

In the step S1001, the optimal variable candidate generation section 101 generates a plurality of optimal variable candidates, based on a belief distribution. In the step S1002, the objective function evaluation section 102 evaluates an objective function for each of the plurality of optimal variable candidates. In the step S1003, the inverse temperature optimization section 103 calculates, by using an optimization technique, an inverse temperature such that a target effective sample size which has been inputted and an effective sample size of a weight for the objective function are substantially equal to each other. In the step S1004, the weight evaluation section 104 calculates the weight for the objective function, based on the inverse temperature. In the step S1005, the belief distribution updating section 105 updates the belief distribution, based on the weight, the belief distribution, and each of the optimal variable candidates.

### <Implementation Example by Program>

When the optimization apparatus 100 is constituted by a computer, the following program is stored in a memory to which the computer refers. The program is a program for causing a computer to function as the optimization apparatus 100, the program causing the computer to function as: the optimal variable candidate generation section 101 that generates a plurality of optimal variable candidates, based on a belief distribution; the objective function evaluation section 102 that evaluates an objective function for each of the plurality of optimal variable candidates; the inverse temperature optimization section 103 that calculates, by using an optimization technique, an inverse temperature such that a target effective sample size which has been inputted and an effective sample size of a weight for the objective function are substantially equal to each other; the weight evaluation section 104 that calculates the weight for the objective function, based on the inverse temperature; and the belief distribution updating section 105 that updates the belief distribution, based on the weight, the belief distribution, and each of the optimal variable candidates.

By reading and executing the program from the memory, the computer achieves the aforementioned optimization method M100.

### Example Advantage of Present Example Embodiment

As discussed above, the present example embodiment employs the configuration of: generating a plurality of optimal variable candidates, based on a belief distribution; evaluating an objective function for each of the plurality of optimal variable candidates; calculating, by using an optimization technique, an inverse temperature such that a target effective sample size which has been inputted and an effective sample size of a weight for the objective function are substantially equal to each other; calculating the weight for the objective function, based on the inverse temperature; and updating the belief distribution, based on the weight, the belief distribution, and each of the optimal variable candidates.

Thus, it is possible to bring about an example advantage of making it possible to adjust an inverse temperature used in nonlinear optimization problems to a more suitable value.

### Second Example Embodiment

The following description will discuss a second example embodiment of the present invention in detail with reference to the drawings. The same reference numerals are given to constituent elements which have functions identical with those discussed in the first example embodiment, and descriptions as to such constituent elements are omitted as appropriate.

### <Configuration of Optimization System 1>

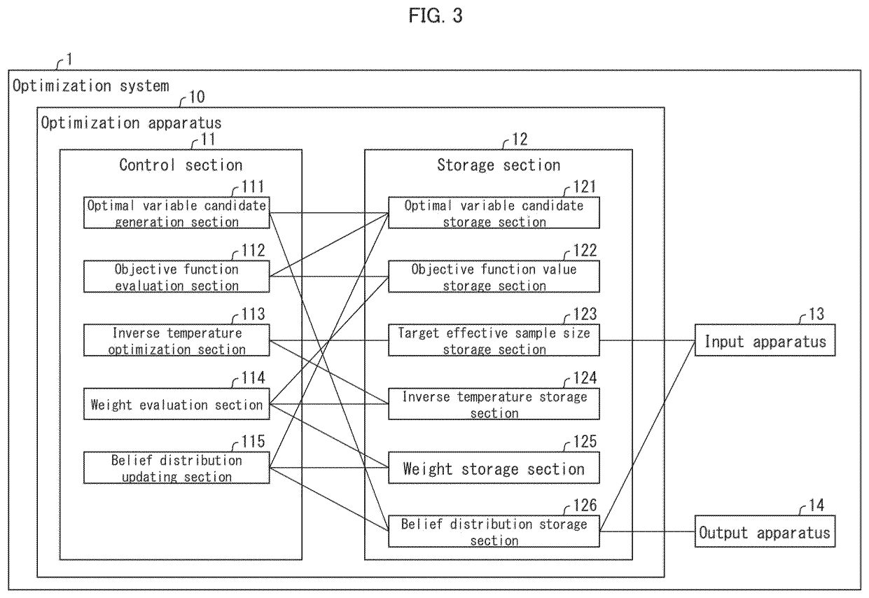

The configuration of an optimization system 1 in accordance with the present example embodiment will be discussed with reference to FIG. 3. FIG. 3 is a block diagram illustrating the configuration of the optimization system 1. As illustrated in FIG. 3, the optimization system 1 includes an optimization apparatus 10, an input apparatus 13, and an output apparatus 14. The optimization apparatus 10 includes a control section 11 and a storage section 12.

The control section 11 controls each section of the optimization apparatus 10. The control section 11 includes an optimal variable candidate generation section 111, an objective function evaluation section 112, an inverse temperature optimization section 113, a weight evaluation section 114, and a belief distribution updating section 115. The control section 11 controls the storage section 12, and refers to data in the storage section 12 and records data into the storage section 12.

The storage section 12 includes an optimal variable candidate storage section 121, an objective function value storage section 122, a target effective sample size storage section 123, an inverse temperature storage section 124, a weight storage section 125, and a belief distribution storage section 126.

The input apparatus 13 receives an input operation from a user. Examples of the input apparatus 13 include, but are not limited to, a keyboard, a mouse, and a touch pad. For example, the input apparatus 13 receives an operation of inputting information which indicates a target effective sample size and an initial belief distribution.

The output apparatus 14 outputs information in response to the control by the control section 11. Examples of the output apparatus 14 include, but are not limited to, a liquid crystal display and a speaker. For example, the output apparatus 14 outputs information which indicates a belief distribution ultimately calculated by the control section 11.

The optimal variable candidate generation section 111 generates a plurality of optimal variable candidates on the basis of a belief distribution in the belief distribution storage section 126, and records the plurality of optimal variable candidates in the optimal variable candidate storage section 121. It should be noted that the optimal variable candidate generation section 111 generates the plurality of optimal variable candidates, based on the initial belief distribution which has been inputted from the input apparatus 13 or on the belief distribution which has been updated by the belief distribution updating section 115. For example, the initial belief distribution is referenced to generate a plurality of optimal variable candidates during the first iteration of the loop process discussed later. The belief distribution which has been updated is referenced to generate a plurality of optimal variable candidates during the second and subsequent iterations of the loop process.

The objective function evaluation section 112 evaluates the objective function for each optimal variable candidate in the optimal variable candidate storage section 121 and records the objective function value in the objective function value storage section 122.

The inverse temperature optimization section 113 calculates, by an optimization technique, an inverse temperature such that the target effective sample size inputted via the input apparatus 13 and stored in the target effective sample size storage section 123 and the effective sample size of the weight are substantially equal to each other, and records the inverse temperature in the inverse temperature storage section 124. It should be noted here that the expression that “a target effective sample size and an effective sample size of a weight being substantially equal” may mean that, for example, these sizes are equal. In addition, the expression that “a target effective sample size and an effective sample size of a weight being substantially equal” may mean that, for example, the difference between these sizes falls within a predetermined range. However, the expression that “a target effective sample size and an effective sample size of a weight being substantially equal” is not limited to these descriptions.

On the basis of the inverse temperature in the inverse temperature storage section 124, the weight evaluation section 114 evaluates the weight for each objective function value in the objective function value storage section 122 and records the weight in the weight storage section 125.

On the basis of each optimal variable candidate in the optimal variable candidate storage section 121, each weight in the weight storage section 125, and the belief distribution in the belief distribution storage section 126, the belief distribution updating section 115 approximately calculates the posterior belief distribution, and records the posterior belief distribution as a new belief distribution in the belief distribution storage section 126.

### <Flow of Optimization Method M10>

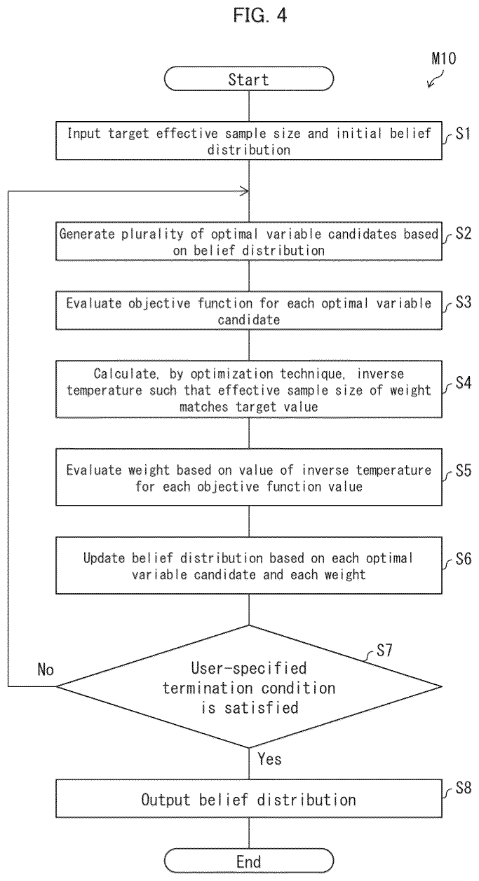

The optimization system 1, which is configured as discussed above, carries out an optimization method M10 in accordance with the present example embodiment. The flow of the optimization method M10 will be discussed with reference to FIG. 4. FIG. 4 is a flowchart illustrating the flow of the optimization method M10. As illustrated in FIG. 4, the optimization method M10 includes steps S1 through S8.

In a step S1, the control section 11 receives an input of a target effective sample size and an initial belief distribution via the input apparatus 13. The control section 11 also records the obtained target effective sample size in the target effective sample size storage section 123. The control section 11 also records the obtained initial belief distribution in the belief distribution storage section 126.

Subsequently, the control section 11 repeats steps S2 through S8. The process of performing and repeating the steps S2 through S8 will also be referred to as a loop process.

In the step S2, the optimal variable candidate generation section 111 generates a plurality of optimal variable candidates, based on a belief distribution. In the first iteration of the loop process, the belief distribution used for the generation is the initial belief distribution in the belief distribution storage section 126. In the second and subsequent iterations of the loop process, the belief distribution used for the generation is the belief distribution which has been updated in the step S7 in the previous iteration of the loop process. It should be noted that the updated belief distribution is recorded in the belief distribution storage section 126. The optimal variable candidate generation section 111 records, in the optimal variable candidate storage section 121, the plurality of optimal variable candidates which have been generated.

In the step S3, the objective function evaluation section 112 evaluates the objective function for each optimal variable candidate in the optimal variable candidate storage section 121 and records, in the objective function value storage section 122, the objective function value which is an evaluation result.

In the step S4, the inverse temperature optimization section 113 calculates, by an optimization technique, an inverse temperature such that the target effective sample size in the target effective sample size storage section 123 and the effective sample size of the weight are equal, and records the inverse temperature in the inverse temperature storage section 124.

In the step S5, on the basis of the inverse temperature in the inverse temperature storage section 124, the weight evaluation section 114 evaluates the weight for each objective function value in the objective function value storage section 122 and records the weight in the weight storage section 125.

In the step S6, on the basis of each optimal variable candidate in the optimal variable candidate storage section 121, each weight in the weight storage section 125, and the belief distribution in the belief distribution storage section 126, the belief distribution updating section 115 approximately calculates the posterior belief distribution, and records the posterior belief distribution as a new belief distribution in the belief distribution storage section 126. In the first iteration of the loop process, the belief distribution on which the approximate calculation of the posterior belief distribution is based is the initial belief distribution in the belief distribution storage section 126. In the second and subsequent iterations of the loop process, the belief distribution on which the approximate calculation of the posterior belief distribution is based is the belief distribution which has been updated in the step 6 in the previous iteration of the loop process.

In the step S7, the control section 11 determines whether or not a predetermined termination condition is satisfied. The predetermined termination condition may be specified by a user.

If it is determined in the step S7 that the predetermined termination condition is satisfied (“Yes”), the control section 11 in the step S8 outputs the belief distribution to the output apparatus 14 and ends the optimization method M10.

If it is determined in the step S7 that the predetermined termination condition is not satisfied (“No”), the control section 11 repeats the steps S2 through S8 in the loop process on the basis of the updated belief distribution.

### Example Advantage of Present Example Embodiment

The present example embodiment employs the configuration in which the inverse temperature optimization section 113 calculates an inverse temperature such that the target effective sample size and the effective sample size of a weight are substantially equal to each other.

Thus, it is possible to allow for fixation of the effective sample size. This makes it possible to adjust the magnitude of sampling errors that occur in the approximate calculation of the posterior belief distribution, and therefore makes it possible to perform stable updates. In addition, by setting the target effective sample size as small as possible within the tolerable range of the sampling error, a good balance between the stability and efficiency of the updates can be ensured. Alternatively, by setting a larger target effective sample size, the stability of the updates can be prioritized. Overall, by automatically adjusting the inverse temperature to fix the effective sample size, the difficulty of adjusting the inverse temperature can be improved.

The present example embodiment employs the configuration in which the optimal variable candidate generation section 111 generates the plurality of optimal variable candidates, based on the initial belief distribution which has been inputted from the input apparatus 13 or on the belief distribution which has been updated by the belief distribution updating section 115.

Thus, in addition to the same example advantage as the first example embodiment, the present example embodiment brings about the example advantage that, each time the belief distribution is updated, it is possible to adjust, to a suitable value, the inverse temperature for calculating the weight used in the updating.

### Third Example Embodiment

The following description will discuss a third example embodiment of the present invention in detail with reference to the drawings. The same reference numerals are given to constituent elements which have functions identical with those discussed in the first and second example embodiments, and descriptions as to such constituent elements are omitted as appropriate.

### <Configuration of Optimization System 2>

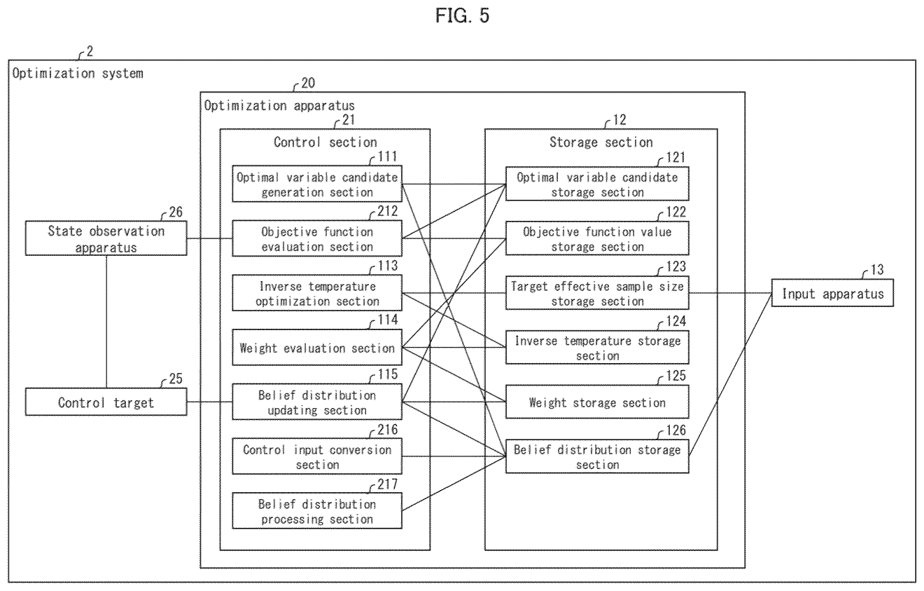

The configuration of an optimization system 2 in accordance with the present example embodiment will be discussed with reference to FIG. 5. FIG. 5 is a block diagram illustrating the configuration of the optimization system 2. As illustrated in FIG. 5, the optimization system 2 includes an optimization apparatus 20, an input apparatus 13, a control target 25, and a state observation apparatus 26. The optimization apparatus 20 includes a control section 21 and a storage section 12. The storage section 12 is as discussed in the second example embodiment. The control section 21 is configured substantially in the same manner as the control section 11 in the second example embodiment except that the control section 21 includes an objective function evaluation section 212 instead of the objective function evaluation section 112 and further includes a control input conversion section 216 and a belief distribution processing section 217.

The objective function evaluation section 212 is configured basically in the same manner as the objective function evaluation section 112 except that the objective function evaluation section 212 evaluates, for each of a plurality of optimal variable candidates, the objective function that depends on the state of the control target 25 observed by the state observation apparatus 26. For example, the objective function evaluation section 212 may use information on the state of the control target 25 transmitted from the observation apparatus 24 to evaluate the objective function for each of the plurality of optimal variable candidates. If a plurality of states of the control target 25 are observed, the objective function evaluation section 212 may evaluate the objective function by using the state that corresponds to the intended use by the user. The intended use by the user may be specified by user input.

On the basis of the belief distribution recorded in the belief distribution storage section 126 by the belief distribution updating section 115, the control input conversion section 216 calculates control input in accordance with a predetermined conversion rule. The control input conversion section 216 then transmits the calculated control input to the control target 25. It should be noted here that the conversion rule can vary depending on the intended use by the user. For example, the predetermined conversion rule may be specified by user input. The control input is information which is inputted for controlling the control target 25. For example, the control input may be an optimal variable candidate that yields the mode of the belief distribution.

The control target 25 receives the control input from the control input conversion section 216 and operates in accordance with the control input. The control target 25 is any apparatus or system capable of performing control. Examples of the control target 25 include, but are not limited to, a robot, an automobile, an excavator, a ship, a chemical plant system, a power plant system, and a trading system. It should be noted that the control target 25 may have the function of autonomously controlling the control target 25 itself according to the received control input. In addition, the control target 25 may have the function of controlling the control target 25 itself by an operation of an operator. In this case, the operator may control the control target 25 in accordance with the control input received by the control target 25.

The state observation apparatus 26 observes the state of the control target 25 and transmits the observed state to the objective function evaluation section 212.

The belief distribution processing section 217 processes the belief distribution recorded in the belief distribution storage section 126 by the belief distribution updating section 115, for the next series of steps, that is, the loop process carried out by the optimal variable candidate generation section 111, the objective function evaluation section 112, the inverse temperature optimization section 113, the weight evaluation section 114, and the belief distribution updating section 115. The belief distribution processing section 217 then records the processed belief distribution in the belief distribution storage section 126. Such processing is performed, for example, when it is necessary to modify the definition of the optimal variable and prepare a belief distribution corresponding to the modified optimal variable. The belief distribution processing section 217 may process the belief distribution according to the intended use by the user. The intended use by the user may be specified by user input.

### <Flow of Optimization Method M20>

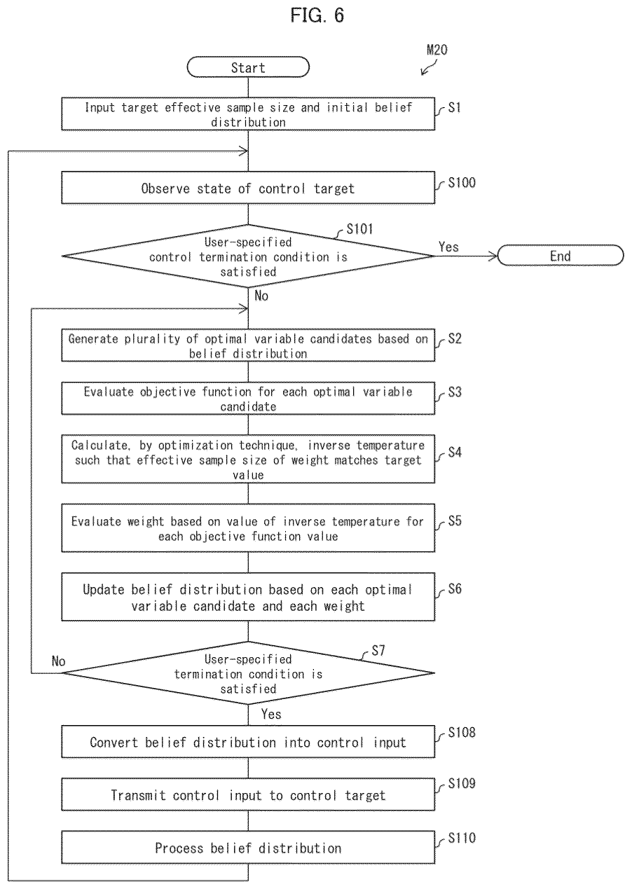

The optimization system 2, which is configured as discussed above, carries out an optimization method M20 in accordance with the present example embodiment. The flow of the optimization method M20 will be discussed with reference to FIG. 6. FIG. 6 is a flowchart illustrating the flow of the optimization method M20.

The optimization method M20 differs from the optimization method M10 in accordance with the second example embodiment in the points below.

The first point is that steps S100 through S101 are carried out after a step S1 and before a step S2. The second point is that steps S108 through S110 are carried out instead of the step S8 if it is determined in a step S7 that a termination condition is satisfied (“Yes”). In the following description, these steps different from the optimization method M10 will be discussed, and identical steps will not be discussed again.

In the step S100, the state observation apparatus 26 observes the state of the control target 25 and transmits the observed state to the objective function evaluation section 212.

In the step S101, the control section 21 determines whether or not a control termination condition is satisfied. The control termination condition may be specified by user input.

If it is determined in the step S101 that the control termination condition is not satisfied (“No”), the optimization system 2 repeats the process from the step S2. If it is determined in the step S101 that the control termination condition is satisfied (“Yes”), the optimization system 2 ends the optimization method M20.

If a plurality of states are observed in the step S100, the state corresponding to the intended use by the user is used during the evaluation of the objective function by the objective function evaluation section 212 in the step S3.

In the step S108, the control input conversion section 216 converts the belief distribution into control input.

In the step S109, the control input conversion section 216 transmits the control input obtained as a result of the conversion to the control target 25.

In the step S110, the belief distribution processing section 217 processes, according to the intended use by the user, the belief distribution which has been updated by the belief distribution updating section 115. The belief distribution processing section 217 then records the processed belief distribution in the belief distribution storage section 126. For example, the intended use by the user is specified by user input.

### Example Advantage of Present Example Embodiment

The present example embodiment employs, in addition to configurations same as those of the first and second example embodiments, the configuration of evaluating, for each of a plurality of optimal variable candidates, the objective function that depends on the state of the control target 25 observed by the state observation apparatus 26. The present example embodiment also employs the configuration of calculating control input on the basis of an updated belief distribution in accordance with a predetermined conversion rule and then transmitting the calculated control input to the control target 25. Furthermore, the present example embodiment employs the configuration of processing the belief distribution updated in a given step, for a loop process carried out by the optimal variable candidate generation section 111, the objective function evaluation section 212, the inverse temperature optimization section 113, the weight evaluation section 114, and the belief distribution updating section 115 in the next step.

In other words, according to the present example embodiment, the control input conversion section 216 transmits, to the control target 25, the control input which is calculated in accordance with a user-specified conversion rule on the basis of the belief distribution updated by the belief distribution updating section 115, and the control target 25 operates in accordance with the control input. In addition, the state of the control target 25 is observed by the state observation apparatus 26, the observed state is transmitted to the objective function evaluation section 212, and the belief distribution processing section 217 then processes the updated belief distribution according to the intended use by the user for the next series of steps in the optimization process.

Thus, the present example embodiment brings about the example advantage of making it possible for the user of the optimization system 2 to perform, for example, optimal control, model predictive control, and online optimization with automatic adjustment of the inverse temperature.

In particular, in these applications, changes in the objective function and the objective variable typically occur along with changes in the state of the control target 25, and it is therefore more difficult to manually set a suitable inverse temperature. In contrast, according to the present example embodiment, the inverse temperature is automatically adjusted such that the effective sample size of the weight always remains constant despite such changes. This makes it possible to maintain consistent efficiency and stability in Bayesian updating.

### Example of Application of Third Example Embodiment

The following description will discuss an optimization system 2A, which is an application example of the third example embodiment. The optimization system 2A is an example in which the control target 25 in the above-discussed optimization system 2A is applied to a hydraulic excavator MV. For example, the optimization system 2A can be utilized to automate a soil leveling operation performed by a bucket B of the hydraulic excavator MV.

### <Configuration of Optimization System 2A>

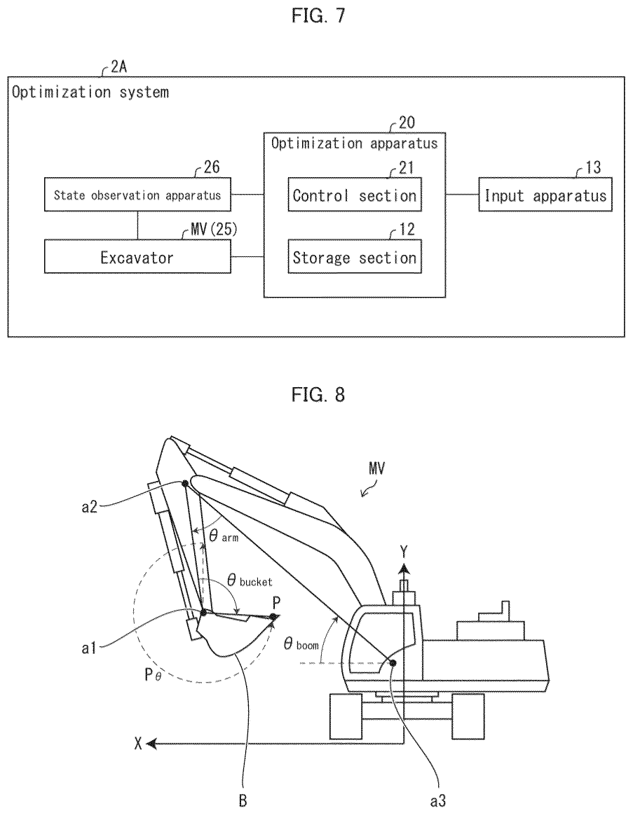

The configuration of the optimization system 2A in accordance with the present application example will be discussed with reference to FIG. 7. FIG. 7 is a block diagram illustrating the configuration of the optimization system 2A.

As illustrated in FIG. 7, the optimization system 2A is configured substantially in the same manner as the optimization system 2 except that the optimization system 2A includes the hydraulic excavator MV as the control target 25.

The present application example will also discuss an example in which the optimization apparatus 20 is constituted by a computer. The computer that configures the optimization apparatus 20 includes at least a processor, a memory, and a network interface. The optimization apparatus 20 may also include, for example, a reading apparatus and a magnetic storage apparatus. The reading apparatus is for reading a computer-readable storage medium such as a universal serial bus (USB) memory and a compact disc read only memory (CD-ROM).

The control section 21 is constituted by a processor. The control section 21 deploys, onto the memory, a program code received from the network interface. Alternatively, the control section 21 reads a program code stored in, for example, a storage medium or a magnetic storage apparatus, and then deploys the program code onto the memory. The processor interprets and executes the deployed program code so as to cause the computer to function as the optimal variable candidate generation section 111, the objective function evaluation section 212, the inverse temperature optimization section 113, the weight evaluation section 114, the belief distribution updating section 115, the control input conversion section 216, and the belief distribution processing section 217.

For example, the optimization apparatus 20 is a so-called personal computer (hereinafter referred to as “PC”). This PC is equipped with a central processing unit (CPU) having a clock frequency of 3.20 gigahertz (GHz) and a graphical processing unit (GPU) including 10,496 NVIDIA CUDA cores.

The storage section 12 is constituted by, for example, the memory and the magnetic storage apparatus which are included in the optimization apparatus 20. The storage section 12 includes the optimal variable candidate storage section 121, the objective function value storage section 122, the target effective sample size storage section 123, the inverse temperature storage section 124, the weight storage section 125, and the belief distribution storage section 126. In the present application example, the storage section 12 is a GPU memory including with a storage capacity of 16 gigabytes (GB).

The input apparatus 13 is, for example, a keyboard, a mouse, and/or a touch pad which is/are connected to the optimization apparatus 20.

The hydraulic excavator MV includes a remote operation system. Hereinafter, the hydraulic excavator MV may be simply referred to as “excavator MV”. This remote operation system is connected to the optimization apparatus 20 via, for example, wireless communication such as Wi-Fi (registered trademark). The remote operation system receives control input from the optimization apparatus 20 and, according to the control input, remotely operates the control lever of the excavator MV.

The movable range of the control lever in the present application example will be discussed with reference to FIG. 8. FIG. 8 is a diagram schematically illustrating an example of the movable range of the control lever. In FIG. 8, an X-Y coordinate system is defined by, in a rotation plane where the bucket, an arm, and a boom of the excavator MV can rotate, an X-axis which is the horizontal direction and a Y-axis which is the vertical direction. As illustrated in FIG. 8, the excavator MV has the bucket B and the control lever which is not illustrated. The movable range of the control lever is limited to the range corresponding to the rotational movements around a bucket axis a1, an arm axis a2, and a boom axis a3 of the excavator MV. Since the direction and the intensity of the rotational movement around each axis is determined by the tilt of the control lever, the control input specifies the degree of tilt of the control lever. For convenience, control input uₜ at a discrete time t represented by any natural number is defined by the following formula (1).

$${u}_{t} = {( {u}_{bucket , t} , {u}_{arm , t} , {u}_{boom , t} )}^{T} \qquad ( 1 )$$

The components represent the tilts of the control lever corresponding to the rotational movements around the bucket axis a1, the arm axis a2, and the boom axis a3 and are expressed as numerical values from −1.0 to 1.0. The positive or negative of the value indicates the direction of the rotational movement (direction in which the control lever is tilted). In addition, the absolute value of the value indicates the degree of tilt. For example, a value of zero indicates no tilt, while a value of 1 indicates the maximum tilt. In addition, the control cycle is set to 80 milliseconds.

The state observation apparatus 26 observes the state of the excavator MV and transmits the observed state to the optimization apparatus 20. In the present application example, the state observation apparatus 26 is an inertial measurement unit (hereinafter referred to as IMU) included in the excavator MV. The IMU observes the joint angles of the excavator MV at discrete time t, that is, the following three angles illustrated in FIG. 8: θbucket, θarm, and θboom. The θbucket indicates the angle around the bucket axis a1. The θarm indicates the angle around the arm axis a2. The θboom indicates the angle around the boom axis a3. In the present application example, these three angles are defined as the state xₜ of the excavator MV at discrete time t, and are expressed by the following formula (2).

$${x}_{t} = {θ}_{t} = {( {θ}_{bucket , t} , {θ}_{arm , t} , {θ}_{boom , t} )}^{T} \qquad ( 2 )$$

In addition, the observation cycle is synchronized with the control cycle, so that the observation timing occurs immediately after the control input timing. Hereinafter, all angles will be regarded as being expressed in the unit of [deg.] unless otherwise specified.

### <Flow of Optimization Method M20A>

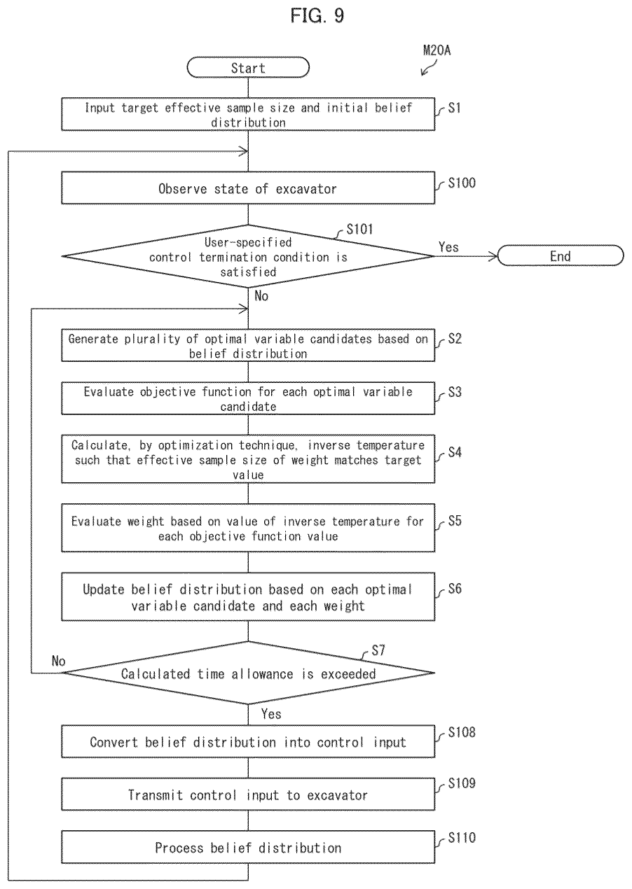

The optimization system 2A configured as discussed above carries out the optimization method M20A. The optimization method M20A is a specific example of carrying out the optimization method M20 with the excavator MV as the target. The optimization method M20A will be discussed with reference to FIG. 9. FIG. 9 is a flowchart illustrating the flow of the optimization method M20A. The details of each step will be discussed below. It should be noted that the discussions of points similar to those of the optimization method M20 will not be repeated in detail, and the points different from those of the optimization method M20 will be the main focus in the following discussion.

In a step S1, a user uses the input apparatus 13 to input a target effective sample size and an initial belief distribution. It is assumed here that a target effective sample size of Nefftarget=300 is inputted.

In a step S100, the state observation apparatus 26 observes the state of the excavator MV.

In the step S101, if the observed state xₜ reaches the final target coordinates of the reference trajectory, it is determined that the control termination condition is satisfied (“Yes”). The details of the reference trajectory and the target coordinates will be discussed later.

The objective variable will be defined first in order to define the belief distribution. In the present application example, the prediction horizon H in model predictive control is set to 20, and the objective variables are defined as control inputs over H steps from the current discrete time t to t+H−1. This is expressed as shown in the following formula (3).

$${u}_{t : H} = ( {u}_{t} , … , {u}_{t + H - 1} ) \qquad ( 3 )$$

Hereinafter, not only for control inputs but also for other variables, the notation “discrete time: number of steps” will be used to indicate that the variables include each time up to H steps ahead. The belief distribution is defined as a multivariate Gaussian distribution as shown in the following formula (4).

$$q ( {v}_{t : H} \vert {u}_{t : H} ) = {\sum }_{s = t}^{t + H - 1} \frac{1}{\sqrt{{( 2 π )}^{d} det ( \sum )}} exp ( - \frac{{( {v}_{s} - {u}_{s} )}^{T} {\sum }^{- 1} ( {v}_{s} - {u}_{s} )}{2} ) \qquad ( 4 )$$

It should be noted here that “vt:H” represents the optimal variable candidate. “d” represents the dimensionality of “uₜ” and is 3 in the present application example. “E” represents a d-dimensional covariance matrix. In the present application example, the initial belief distribution is set with all components of “uₜ: H” as 0, all off-diagonal components of “E” as 0, and all diagonal components as 0.09.

In a step S2, the optimal variable candidate generation section 111 generates a plurality of optimal variable candidates on the basis of belief distributions in the belief distribution storage section 126; the initial belief distribution given at the input apparatus 13 for the first iteration and the belief distribution updated by the belief distribution updating section 115 for the subsequent iterations in the loop process. The optimal variable candidate generation section 111 then records the optimal variable candidates in the optimal variable candidate storage section 121. In the present application example, the number K of optimal variable candidates generated is set to 64000, and Monte Carlo sampling (MC sampling) is used to generate the optimal variable candidates.

In a step S3, the objective function evaluation section 212 evaluates the objective function for each optimal variable candidate in the optimal variable candidate storage section 121 and records the objective function value in the objective function value storage section 122. In the present application example, the objective function predicts state transition (trajectory) when the control inputs vt:H are sequentially performed from the current state xₜ, and evaluates the predicted trajectory. First, the state transition function is modeled as shown in the following formula (5).

$${x}_{t + 1} = f ( {x}_{t} , {v}_{t} ) \qquad ( 5 )$$

f(xₜ, vt) is, for example, a fully connected neural network and is a model constituted by two fully connected layers each having 64 nodes and using the tanh function as an activation function. By recursively using this state transition model, “xₜ+1: H” is calculated from “xₜ” and “vt:H”. The model parameters are assumed to be pre-trained in advance using operation data of the excavator MV. The total cost function for “xₜ+1: H” and “vt:H” is defined as shown in the following formula (6).

$$C ( {x}_{t : H + 1} , {u}_{t : H} ) = {\sum }_{s = t}^{t + H} c ( {x}_{s} , {x}_{s} + 1 ) \qquad ( 6 )$$

Here, “c” is the immediate cost function. In the present application example, in order to construct a trajectory-following control system, the immediate cost function is defined as shown in the following formula (7).

$$c ( {x}_{s} , {x}_{s + 1} ) = {{a}_{x} ( {p}_{x , s + 1} - {p}_{x , s + 1}^{ref} )}^{2} + {{a}_{y} ( {p}_{y , s + 1} - {p}_{y , s + 1}^{ref} )}^{2} + {{a}_{θ} ( {p}_{θ , s + 1} - {p}_{θ , s + 1}^{ref} )}^{2} \qquad ( 7 )$$

Here, “px,s+1”, “py,s+1”, and “pθ,s+1” represent the X and Y coordinates [m] and the azimuth angle of the tip point P of the bucket B illustrated in FIG. 8, at discrete time s+1. “px, s+1”, “py, s+1”, and “pθ,s+1” are geometrically calculated on the basis of “Os+1” from the structure of the excavator. “prefx, s+1”, “prefy, s+1”, and “prefθ,s+1” are the target coordinates at discrete time s+1.

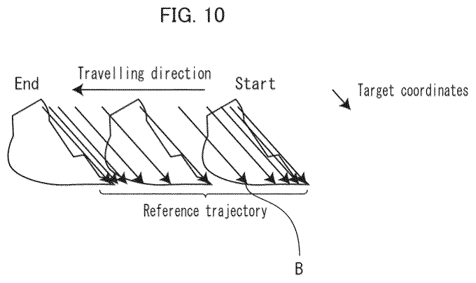

The reference trajectory in the present application example will be discussed with reference to FIG. 10. FIG. 10 is a schematic diagram for discussing the reference trajectory. As illustrated in FIG. 10, the reference trajectory is constructed so that the tip P of the bucket B moves horizontally while maintaining the height from the ground surface and constantly maintaining the blade of the bucket B in the horizontal direction. For example, the reference trajectory is constructed so that the tip P of the bucket B moves horizontally between 0.63 m and 1.43 m in the X-axis direction from the rotational axis of the excavator MV, while maintaining a height of 0.89 m from the ground surface. Each arrow in FIG. 10 indicates target coordinates that constitute the reference trajectory, with the arrowhead indicating prefx, prefy and the direction of the arrow indicating prefθ. To avoid sudden starts and stops, the placement of the target coordinates is adjusted to include three phases: acceleration, constant speed, and deceleration. Although FIG. 10 shows an example of a task involving horizontal movement in the forward direction, reference trajectories for tasks in the reverse direction are constructed based on a similar approach.

“ax”, “ay”, and “aθ” are coefficients that determine the weights of the costs of respective terms and are set to 10000, 10000, and 10, respectively, in the present application example. The composite function of the total cost function and the state transition function discussed above is defined as an objective function S in the present application example.

In the step S4, the inverse temperature optimization section 113 calculates, by an optimization technique, an inverse temperature λ such that the target effective sample size Nefftarget in the target effective sample size storage section 123 and the effective sample size of the weight are equal, and records the inverse temperature λ in the inverse temperature storage section 124. The weight for each optimal variable candidate is the value obtained by dividing the likelihood by the marginal likelihood, and is therefore as shown in the following formula (8).

$${ω}^{( k )} = \frac{exp [ - \frac{1}{λ} ( S ( {v}_{t : H}^{( k )} ) - {S}_{min} ) ]}{{\sum }_{j = 1}^{K} exp [ - \frac{1}{λ} ( S ( {v}_{t : H}^{( j )} ) - {S}_{min} ) ]} \qquad ( 8 )$$

Here, “S (vt:H(k))” is the objective function value evaluated for the k-th optimal variable candidate in the step S3. “Smin” is the minimum value among all of K objective function values and is added to improve the accuracy of the numerical calculation. In the present application example, the Kish's approximate effective sample size, shown in the following formula (9), is employed as an effective sample size.

$${N}_{eff} ( λ ) = K \frac{{\overline{ω}}^{2}}{\overline{{ω}^{2}}} \qquad ( 9 )$$

Here, the horizontal bar above the symbol represents the arithmetic mean of all of K weights. In the present application example, the inverse temperature optimization section 113 uses the Brent method, a type of nonlinear optimization, to minimize the objective function shown in the following formula (10) so as to calculate the A that makes “Neff (A)=Nefftarget”. The inverse temperature optimization section 113 then records the A in the inverse temperature storage section 124.

$$L ( λ ) = {( {N}_{eff} ( λ ) - {N}_{eff}^{target} )}^{2} \qquad ( 10 )$$

In the step S5, on the basis of the inverse temperature in the inverse temperature storage section 124, the weight evaluation section 114 evaluates the weight (formula (8)) for each objective function value in the objective function value storage section 122 and records the weight in the weight storage section 125.

In the step S6, on the basis of each optimal variable candidate in the optimal variable candidate storage section 121, each weight in the weight storage section 125, and the belief distribution in the belief distribution storage section 126, the belief distribution updating section 115 approximately calculates, by the moment matching method, the posterior belief distribution, and records the posterior belief distribution as a new belief distribution in the belief distribution storage section 126. Since the moment matching method is used, the approximate posterior belief distribution also becomes a Gaussian distribution as shown in the formula (4), and the mean parameter uₜ: H (control input) thereof is updated as shown in the following formula (11).

$${u}_{t : H} ← {{\sum }^{K}}_{k = 1} {ω}^{( k )} {v}_{t : H}^{( k )} \qquad ( 11 )$$

After the updating, if the user-specified termination condition is not satisfied (“No” in step S7), the series of steps S2 through S6 in the loop process is performed again. In the present application example, the termination condition is considered satisfied (“Yes”) if 60 milliseconds or more have elapsed from the step S100 at the time point at which the condition is checked in the step S7. That is, the updating process is repeated as long as there is sufficient time.

On the other hand, if the user-specified termination condition is satisfied (“Yes” in the step S7), the step S108 is performed. In the step S108, the control input conversion section 216 converts, into control input, the belief distribution which has been updated in the step S6. The conversion is performed as follows.

In the present application example, since the belief distribution is a Gaussian distribution, the optimal variable candidate with the highest probability density matches the mean parameter uₜ: H of the Gaussian distribution. That is, uₜ: H is the most promising optimal variable candidate. The present application example assumes an application to model predictive control. Therefore, in the step S109, the control input conversion section 216 extracts only the element of the optimal variable candidate at the first time point, that is, the element uₜ at discrete time t, and transmits the extracted element to the excavator MV.

In the step S110, the belief distribution processing section 217 processes the belief distribution and records the processed belief distribution in the belief distribution storage section 126. Then, the steps starting from the step S100 in the loop process are repeated. The present application example assumes an application to model predictive control. Therefore, the belief distribution is processed into a belief distribution with the time step shifted by one, that is, into a belief distribution for control input from discrete time t+1 to t+H. First, for the elements from discrete time t+1 to t+H−1, the elements of uₜ: H from discrete time t+1 to t+H−1 are directly employed. For the element at t+H, a three-dimensional 0 vector is employed, just as when the initial belief distribution was set. The uₜ+1: H configured in this way is employed as the parameter for the next initial belief distribution. It should be noted that when transition is made to the step S100 in the loop process, “t←t+1” has been performed.

### Example Advantage of Present Application Example

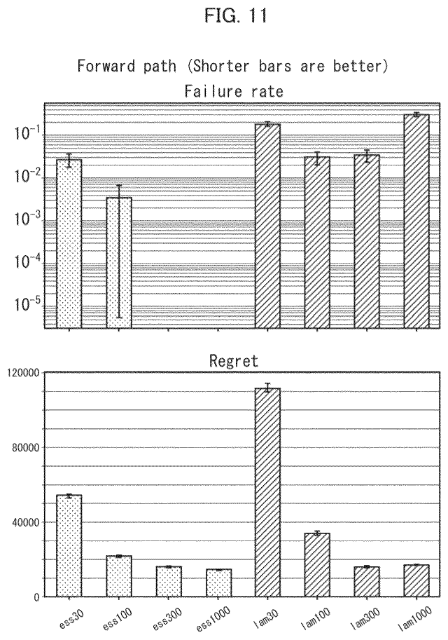

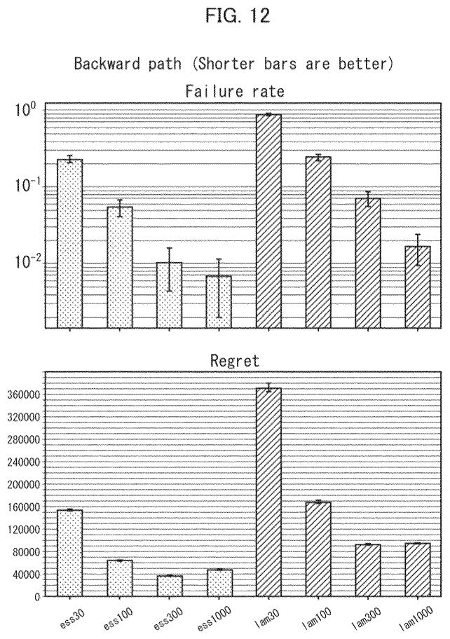

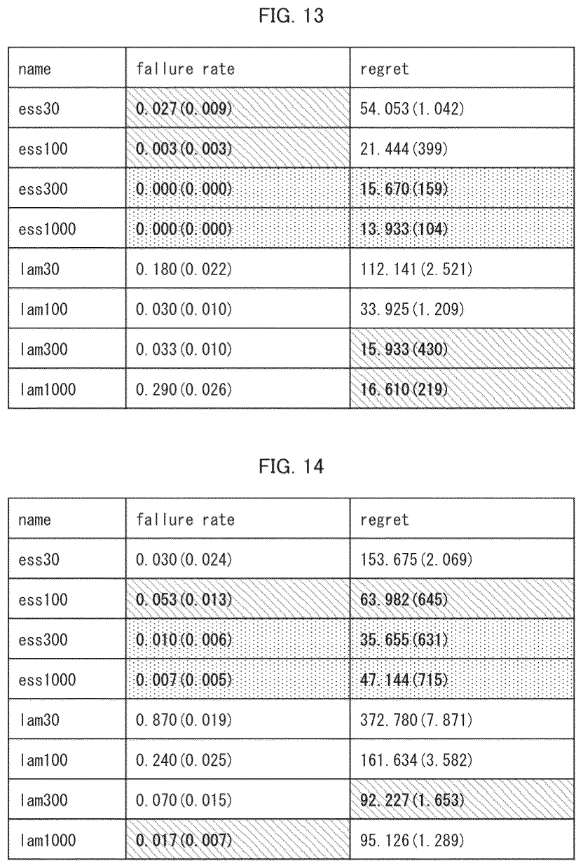

An example advantage of the present application example will be discussed with reference to the graphs in FIGS. 11 and 12 and the tables in FIGS. 13 and 14. FIGS. 11 through 14 are drawings and tables for comparing the performance of the control system between when the inverse temperature is fixed (related techniques in Non-Patent Literatures 1 and 2) and when the inverse temperature is automatically adjusted (present application example). The graphs in FIG. 11 and the table in FIG. 13 evaluate the task of moving the tip P of the bucket B horizontally in the forward direction. The graphs in FIG. 12 and the table in FIG. 14 evaluate the task of moving the tip P of the bucket B horizontally in the reverse direction.

The present performance evaluation was conducted through a simulation of the excavator MV, and the mean values and 1σ confidence intervals were calculated on the basis of 300 trials for each of the following settings. In the tables in FIGS. 13 and 14, the 1σ confidence interval is indicated in parentheses. Experiments were conducted for a total of eight settings in which Δ was fixed at 30, 100, 300, and 1000 and in which Nefftarget when the inverse temperature was automatically adjusted as in the present application example was set to 30, 100, 300, and 1000. In the graphs in FIGS. 11 and 12 and the tables in FIGS. 13 and 14, the settings are indicated as lam30, lam100, lam300, lam1000, ess30, ess100, ess300, and ess1000, respectively.

In the present simulation, a pseudo pulse-type disturbance is added every 20 time steps. This pulse-type disturbance alters the values of (θbucket, t, θarm,t, θboom, t) only by (+4.5, −4.5, +7.5) [deg.] at the discrete time t when the disturbance occurs. It is assumed that this disturbance cannot be predicted in advance and thus it is set so that the disturbance is not accounted for during the trajectory estimation by the objective function evaluation section 212. That is, when the disturbance occurs, there is inevitably a significant deviation from the predicted trajectory. It is therefore necessary to promptly and accurately correct the belief distribution.

In the graphs in FIGS. 11 and 12 and the tables in FIGS. 13 and 14, the failure rate is determined by considering a task as failed if any of the differences between the target coordinates and the current coordinates (| px-prefx |, | py-prefy |, | pe-prefθ |) exceeds (0.1 m, 0.1 m, 10 deg.). At that time point, the task is terminated. Failures mainly occur when the belief distribution cannot be promptly and accurately corrected after a disturbance. For ess300 and ess1000, there were no failures in any of the 300 trials, so that the failure rate is indicated as 0 in FIGS. 11 and 13. Regret indicates the difference in total cost with respect to the optimal control rule. However, since it is difficult to know the optimal control rule in advance for the present task setting, the regret is regarded to indicate the difference from the lowest total cost across all settings and all trials in the present evaluation. Regret is only evaluated for tasks that did not fail. Thus, in settings with a high failure rate, the sample size is smaller. This leads to a larger 1σ confidence interval. In the tables in FIGS. 13 and 14, shaded text and text with a hatched pattern indicate the top two and third and fourth places in each of the failure rate and regret categories.

According to the results shown in the graphs in FIGS. 11 and 12 and the tables in FIGS. 13 and 14, the settings that are generally superior from the viewpoint of failure rate and regret for both forward and reverse-direction tasks are from the ess group. In particular, ess300 and ess1000 are both in the top two in terms of performance for both tasks from the viewpoint of failure rate and regret.

In the forward-direction task, the minimum failure rate for the lam group settings is 3%, whereas all the ess group settings have a failure rate of 3% or less, with ess300 and ess1000 having 0%, in particular. Regarding regret, the minimum regret in the ess group (ess1000, 13,933) exhibits improvement by approximately 1.14 times in comparison with the minimum regret in the lam group (lam300, 15,933).

In the reverse-direction task, the minimum failure rate for the lam group settings is 1.7%, while for ess300 and ess1000, the minimum failure rates are 1% and 0.7%, respectively. Regarding regret, the minimum regret in the ess group (ess300, 35,655) exhibits improvement by approximately 2.59 times in comparison with the minimum regret in the lam group (lam300, 92,227).

It is also indicated that as the target effective sample size in the ess group increases, there is a tendency for the failure rate to decrease. This tendency occurs in the optimization system 2A in accordance with the present application example because an increase in the target effective sample size leads to a decrease in sampling error. In addition, by setting the target effective sample size as small as possible within the tolerable range of the sampling error, a good balance between the stability and efficiency of the updates can be ensured. It was thus possible to maintain a low failure rate and achieve small regret, as seen with ess300. Alternatively, by setting a larger target effective sample size, the stability of the updates can be prioritized. It was thus possible to further reduce the failure rate, as seen with ess1000. Overall, the optimization system 2A in accordance with the present application example can be utilized in model predictive control applications, and the automatic adjustment of the inverse temperature to maintain a constant effective sample size successfully mitigated the difficulties in adjusting the inverse temperature.

Each of the example embodiments and application examples discussed above is a suitable example embodiment of the present invention, and the scope of the present invention is not limited only to each of the example embodiments and application examples. The present invention can be put into practice in many variations within the scope of the present invention.

### Software Implementation Example

Some or all of the functions of each of the optimization apparatuses 10 and 20 may be implemented by hardware such as an integrated circuit (IC chip), or may be implemented by software.

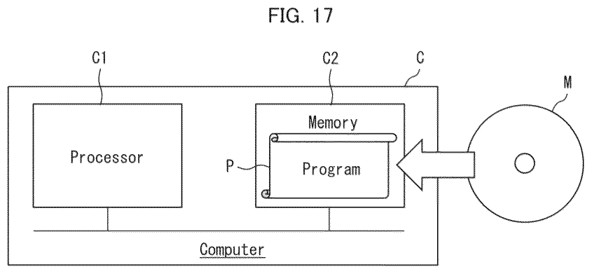

In the latter case, each of the optimization apparatuses 10 and 20 is realized by, for example, a computer that executes instructions of a program that is software realizing the foregoing functions. FIG. 17 illustrates an example of such a computer (hereinafter, referred to as “computer C”). The computer C includes at least one processor C1 and at least one memory C2. The memory C2 stores a program P for causing the computer C to function as the optimization apparatuses 10 and 20. The processor C1 of the computer C retrieves the program P from the memory C2 and executes the program P, so that the functions of the optimization apparatuses 10 and 20 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other devices. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. However, that the present invention is not limited to the following supplementary notes.

### (Supplementary Note 1)

An optimization including: an optimal variable candidate generation means for generating a plurality of optimal variable candidates, based on a belief distribution; an objective function evaluation means for evaluating an objective function for each of the plurality of optimal variable candidates; an inverse temperature optimization means for calculating, by using an optimization technique, an inverse temperature such that a target effective sample size which has been inputted and an effective sample size of a weight for the objective function are substantially equal to each other; a weight evaluation means for calculating the weight for the objective function, based on the inverse temperature; and a belief distribution updating means for updating the belief distribution, based on the weight, the belief distribution, and each of the optimal variable candidates.

### (Supplementary Note 2)

The optimization apparatus according to supplementary note 1, in which the optimal variable candidate generation means generates the plurality of optimal variable candidates, based on an initial belief distribution which has been inputted or on the belief distribution which has been updated by the belief distribution updating means.

### (Supplementary Note 3)

The optimization apparatus according to supplementary note 1 or 2, in which the objective function evaluation means evaluates, for each of the plurality of optimal variable candidates, an objective function which depends on a state of a control target that is observed by a state observation apparatus.

### (Supplementary Note 4)

The optimization apparatus according to any one of supplementary notes 1 through 3, further including a control input conversion means for calculating control input in accordance with a predetermined conversion rule based on the belief distribution which has been updated by the belief distribution updating means and transmitting the calculated control input to a control target.

### (Supplementary Note 5)

The optimization apparatus according to any one of supplementary notes 1 through 4, further including a belief distribution processing means for processing the belief distribution which has been updated by the belief distribution updating means in a given step, for a process to be performed in a next step by the optimal variable candidate generation means, the objective function evaluation means, the inverse temperature optimization means, the weight evaluation means, and the belief distribution updating means.

### (Supplementary Note 6)

A method for optimization, said method including: generating a plurality of optimal variable candidates, based on a belief distribution; evaluating an objective function for each of the plurality of optimal variable candidates; calculating, by using an optimization technique, an inverse temperature such that a target effective sample size which has been inputted and an effective sample size of a weight for the objective function are substantially equal to each other; calculating the weight for the objective function, based on the inverse temperature; and updating the belief distribution, based on the weight, the belief distribution, and each of the optimal variable candidates.

### (Supplementary Note 7)

The method according to supplementary note 6, further including, before the generating the plurality of optimal variable candidates, receiving input of the target effective sample size and an initial belief distribution.

### (Supplementary Note 8)

The method according to supplementary note 6 or 7, further including, after the updating, outputting the belief distribution which has been updated if a predetermined termination condition is satisfied and repeating a process from the generating of the plurality of optimal variable candidates if the predetermined termination condition is not satisfied.

### (Supplementary Note 9)

A program for causing a computer to function as an optimization apparatus, the program causing the computer to function as: an optimal variable candidate generation means for generating a plurality of optimal variable candidates, based on a belief distribution; an objective function evaluation means for evaluating an objective function for each of the plurality of optimal variable candidates; an inverse temperature optimization means for calculating, by using an optimization technique, an inverse temperature such that a target effective sample size which has been inputted and an effective sample size of a weight for the objective function are substantially equal to each other; a weight evaluation means for calculating the weight for the objective function, based on the inverse temperature; and a belief distribution updating means for updating the belief distribution, based on the weight, the belief distribution, and each of the optimal variable candidates.

### [Additional Remark 3]

Furthermore, some of or all of the foregoing example embodiments can also be expressed as below.

An optimization apparatus includes at least one processor, the at least one processor carrying out: an optimal variable candidate generation process of generating a plurality of optimal variable candidates, based on a belief distribution; an objective function evaluation process of evaluating an objective function for each of the plurality of optimal variable candidates; an inverse temperature optimization process of calculating, by using an optimization technique, an inverse temperature such that a target effective sample size which has been inputted and an effective sample size of a weight for the objective function are substantially equal to each other; a weight evaluation process of calculating the weight for the objective function, based on the inverse temperature; and a belief distribution updating process of updating the belief distribution, based on the weight, the belief distribution, and each of the optimal variable candidates.

It should be noted that this optimization apparatus may further include a memory, and the memory may store a program for causing the at least one processor to perform the optimal variable candidate generation process, the objective function evaluation process, the inverse temperature optimization process, the weight evaluation process, and the belief distribution updating process. The program can be stored in a computer-readable non-transitory tangible storage medium.

### REFERENCE SIGNS LIST

1, 2, 2A, 9 Optimization system
10, 20, 90, 100 Optimization apparatus
11, 21, 91, 911 Control section
12,92
13, 93 Input apparatus
14, 94 Output apparatus
24 Observation apparatus
125, 925 Weight storage section
25 Control target
26 State observation apparatus
101, 111, 911 Optimal variable candidate generation
section
102, 112, 212, 912 Objective function evaluation section
103, 113 Inverse temperature optimization section
104, 114, 914 Weight evaluation section
105, 115, 915 Belief distribution updating section
121, 921 Optimal variable candidate storage section
122, 922 Objective function value storage section
123 Target effective sample size storage section
124, 924 Inverse temperature storage section
126, 926 Belief distribution storage section
216 Control input conversion section
217 Belief distribution processing section
C1 Processor
C2 Memory

What is claimed is:

1. An optimization apparatus comprising at least one processor, the at least one processor being configured to carry out:
an optimal variable candidate generation process of generating a plurality of optimal variable candidates, based on a belief distribution;
an objective function evaluation process of evaluating an objective function for each of the plurality of optimal variable candidates;
an inverse temperature optimization process of calculating, by using an optimization technique, an inverse temperature such that a target effective sample size which has been inputted and an effective sample size of a weight for the objective function are substantially equal to each other;
a weight evaluation process of calculating the weight for the objective function, based on the inverse temperature; and
a belief distribution updating process of updating the belief distribution, based on the weight, the belief distribution, and each of the optimal variable candidates.

2. The optimization apparatus according to claim 1, wherein in the optimal variable candidate generation process, the at least one processor generates the plurality of optimal variable candidates, based on an initial belief distribution which has been inputted or on the belief distribution which has been updated in the belief distribution updating process.

3. The optimization apparatus according to claim 1, wherein in the objective function evaluation process, the at least one processor evaluates, for each of the plurality of optimal variable candidates, an objective function which depends on a state of a control target that is observed by a state observation apparatus

4. The optimization apparatus according to claim 1, wherein the at least one processor further comprising carries out
a control input conversion process of calculating control input in accordance with a predetermined conversion rule based on the belief distribution which has been updated in the belief distribution updating process and transmitting the calculated control input to a control target.

5. The optimization apparatus according to claim 1, wherein the at least one processor further carries out
a belief distribution processing process of processing the belief distribution which has been updated in the belief distribution updating process in a given step, for a process to be performed in a next step in the optimal variable candidate generation process, the objective function evaluation process, the inverse temperature optimization process, the weight evaluation process, and the belief distribution updating process.

6. A method for optimization, said method comprising:
at least one processor generating a plurality of optimal variable candidates, based on a belief distribution;
the at least one processor evaluating an objective function for each of the plurality of optimal variable candidates;
the at least one processor calculating, by using an optimization technique, an inverse temperature such that a target effective sample size which has been inputted and an effective sample size of a weight for the objective function are substantially equal to each other;
the at least one processor calculating the weight for the objective function, based on the inverse temperature; and
the at least one processor updating the belief distribution, based on the weight, the belief distribution, and each of the optimal variable candidates.

7. The method according to claim 6, further comprising,
before the generating the plurality of optimal variable candidates,
the at least one processor receiving input of the target effective sample size and an initial belief distribution.

8. The method according to claim 6, further comprising,
after the updating,
the at least one processor outputting the belief distribution which has been updated if a predetermined termination condition is satisfied and
the at least one processor repeating a process from the generating of the plurality of optimal variable candidates if the predetermined termination condition is not satisfied.

9. A non-transitory storage medium storing a program for causing a computer to function as an optimization apparatus, the program causing the computer to carry out:
an optimal variable candidate generation process of generating a plurality of optimal variable candidates, based on a belief distribution;
an objective function evaluation process of evaluating an objective function for each of the plurality of optimal variable candidates;
an inverse temperature optimization process of calculating, by using an optimization technique, an inverse temperature such that a target effective sample size which has been inputted and an effective sample size of a weight for the objective function are substantially equal to each other;
a weight evaluation process of calculating the weight for the objective function, based on the inverse temperature; and
a belief distribution updating process of updating the belief distribution, based on the weight, the belief distribution, and each of the optimal variable candidates.
